(19) United States
(12) Patent Application Publication
(10) Pub. No.: US 2022/0104518 A1
(43) Pub. Date: Apr. 7, 2022

(54) PELLETED COMPOSITIONS OF LEGUME FORAGES AND METHODS OF USE THEREOF

(71) Applicant: World Shepherd Project, Inc., Farmington, GA (US)

(72) Inventor: R. Greg Stewart, Watkinsville, GA (US)

(21) Appl. No.: 17/493,116

(22) Filed: Oct. 4, 2021

Related U.S. Application Data
(60) Provisional application No. 63/086,872, filed on Oct. 2, 2020.
(60) Provisional application No. 63/188,718, filed on May 14, 2021.

(51) Int. Cl. A23K 10/30

(52) U.S. Cl. CPC A23K 10/30

(57) ABSTRACT

Pelleted compositions of legume forages including Arachis glabrata and/or Crotalaria juncea L. are disclosed. Arachis glabrata and/or Crotalaria juncea L. can be pelleted alone or in combination with other forages such as alfalfa, clover, and lespedeza. The pellets can be of various shapes and sizes, for example about 6.3-10.0 mm diameter and/or 13-25 mm length cylinders. The density of per unit of pellets can be about 960-1120 kg/m³. Also disclosed are methods of using the pelleted compositions. Such methods involve improving weight gain or growth of animals by causing the animal to ingest the disclosed compositions. Methods for preventing or treating gastrointestinal nematode infections in animals are also provided. Animals that may benefit from the disclosed compositions include, but are not limited to equidae, ruminants, and zoo animals, for example, horses, cattle (both beef and dairy), sheep, goats, pigs, rabbits, and ostriches.

### CROSS REFERENCE TO RELATED APPLICATIONS

This application claims the benefit of and priority to U.S. Provisional Application No. 63/086,872, filed Oct. 2, 2020, and U.S. Provisional Application No. 63/188,718, filed May 14, 2021, which are hereby incorporated herein by reference in their entirety.

### FIELD OF THE INVENTION

This invention is generally in the field of animal feed compositions, in particular, pelleted animal feeds containing Arachis glabrata and/or Crotalaria juncea L., and methods of using the same.

zBACKGROUND OF THE INVENTION

Forages are considered the cheapest major nutritional component in the diets of ruminants, particularly in the rural and suburban area of the tropics (Oyaniran D K., et al., Livestock Research for Rural Development 30 (4) 2018). The availability of forages in quantity and quality can be adequate for optimum livestock production to ensure a high level of productivity. Forages are classified into grasses; the main source of energy and legumes which are the main source of protein. Legumes are rich in protein, and they have the potential to reduce the cost of feeding animals. The use of forage legumes in livestock production systems has increased in recent years. Herbaceous forage legumes have been identified as potential supplements for ruminants. However, seasonal fluctuations result in their low quality and unavailability, which poses a threat to livestock survival. Farmers are faced with the challenges of sourcing adequate feeds for their stock during dry seasons. During this period, the nutritive value of the forages declines, while animals are faced with reduced feed intake and loss of weight. For many ruminants, their greatest metabolic needs are in the last trimester of pregnancy and the first forty days of milk. It is during this period of need that the requirements increase to allow for the seventy percent of fetal growth that is associated with late gestation. In many parts of the world, this period of time coincides in winter, when quality forages are not in great supply. Therefore, to be able to “put up” forage diets in a shelf stable form is of paramount importance. Many farmers source alternative feeds, including human-edible foods, for their animals.

Furthermore, the drive to increase the output of animal product in some sectors of ruminant livestock production has led to greater use of feeds such as cereal grains and soybeans that are human-edible. This trend has caused concern, since by so doing, ruminants compete not only with monogastric livestock but also with the human population for a limited global area of cultivatable land on which to produce grain crops (Wilkinson J M. And Lee M R F., Animal, 12:8, pp 1735-1743 (2018)).

Intensive livestock production focused only on cereal grains and just barely enough roughage to prevent rumen dysbiosis and acidosis, has removed animals from the field. This change has also precipitated other detrimental changes to the animals, most of which are mitigated by access to forages. More importantly, this change has eliminated the animals' access to the tens of thousands of plant secondary metabolites (PSMs) many of which are healing and growth promoting, and help mitigate greenhouse gases and improve nitrogen utilization. See Puchala, R. et al., Journal of Animal Science, 83(1):182 (2005) and Naumann H D. et al., Journal of Dairy Science, 98:3980-3987 (2015).

Thus, there is a need for alternative forms of animal feeds, such as forage legumes, that provide a stable source of nutrients year-round, while also mitigating potential competition with humans for human-edible foods. Legumes fix nitrogen by the presence of rhizomes and bacteria on their root hairs. Perennial legumes reduce nitrogen fertilizer inputs and can eliminate tillage and loss of topsoil.

Sunn hemp originated in India where it has been grown since the dawn of agriculture. It has been utilized as a green manure, livestock feed, and as a non-wood fiber crop. Sunn hemp (Crotalaria juncea L.) is the fastest growing and most important species of the Crotalaria genus. It has also been grown in Brazil and Bangladesh as a soil-improving crop. As a cover crop, Sunn hemp can produce 5,000-6,000 pounds of biomass per acre in southern climates in 60-90 days. It also can produce 120-140 pounds of nitrogen in the same amount of time. It provides the benefits of a cover crop such as erosion control, soil improvement, plus resistance to rootknot nematode. It requires warm weather for 8 to 12 weeks.

The rhizoma (perennial) peanut (Arachis glabrata Benth.) is a primitive peanut that produces very few seed in contrast to common annual variety peanut (Arachis hypogaea L.). It is a warm season/tropical perennial legume native to South America. Its potential uses include hay and other dehydrated products, pasture, creep grazing, silage, ornamental, conservation cover, and living mulch in association with other crops. Perennial peanut fills a unique niche in Florida because there is no other perennial warm-season legume that rivals its forage quality, persistence, and broad spectrum of uses. Perennial peanut has advantages over alfalfa in establishment and maintenance. Alfalfa must be replanted every 5-6 years because of alleopathic compounds the plant produces preventing other plants and itself from succulent growth. Perennial peanut stands commercially and have been in constant established and useable cultivation for 40 years at the University of Florida's experiment station in Quincy, Fla. This is a consummate perennial fixing nitrogen, decreasing tillage and topsoil loss, with a low carbon footprint.

While such legumes can be prepared and stored as hay to provide feed during dry seasons, this has many drawbacks. For example, the handling characteristics of certain legume forages when put up as dried hays limit the widespread use and commercialization of such valuable feedstocks that are not fit for human consumption. In particular, perennial peanut, Arachis glabrata Benth, has a major handling drawback that limits its use. The rich leafiness and low stem mass of the dried hay product creates a condition some call “shake” or “shatter”, whereby if the product is handled to load or unload, up to 15% of the hay mass will be loosened from the bales and falls to the floor requiring sweeping and bagging to mitigate economic loss. Consequently, few farmers and shopkeepers wish to handle and rehandle it in spite of its exemplary nutritional reputation. As another example, Sunn Hemp (Crotalaria juncea) has a large central stalk that while nutritious, is rejected by many animals in a phenomenon referred to as “sorting”, which in most cases causes the stalk when provided as dry hay to fall to the ground and be lost through trampling. Up to 35-40% of the biomass may be lost this way adding 35-40% resultantly to the nutritional cost of using it in animal diets. If these and other challenges can be overcome through changes in physical forms, these feedstocks could be substituted for cereal grains and other human-edible foods, which should then be reserved for human consumption and low feed conversion mono-gastric species that have difficulty digesting cellulose because of the anatomical design of their gastrointestinal system.

Thus, it is an object of the invention to provide alternative forms of animal feeds, such as forage legumes, that provide a stable source of nutrients year-round.

It is another object of the invention to provide alternative forms of animal feeds, such as forage legumes, that provide a stable source of plant primary metabolites and PSMs year-round.

It is another object of the invention to provide alternative forms of animal feeds that reduce or minimize potential competition with humans for human-edible foods.

It is a further object of the invention to provide compositions of Sunn hemp (Crotalaria juncea L.) pelleted as an animal feed.

It is a further object of the invention to provide compositions of rhizoma peanut (Arachis glabrata Benth.) pelleted as an animal feed.

It is also an object of the invention to provide methods of feeding an animal.

It is also an object of the invention to provide methods of improving feed intake, weight gain, and/or growth of an animal.

It is also an object of the invention to help mitigate greenhouse gases and improve the form of nitrogen released into the environment.

### SUMMARY OF THE INVENTION

Compositions of legume forages including Arachis glabrata and/or Crotalaria juncea L. in the form of pellets are disclosed. Arachis glabrata and/or Crotalaria juncea L. can be pelleted alone, or in combination with other forages. The compositions are particularly useful as animal feeds.

For example, disclosed is an animal feed composition containing one or more legume forages such as Crotalaria juncea L. and/or Arachis glabrata Benth and optionally, one or more feed additives. Preferably, the composition is in the form of a pellet. In some embodiments, the composition further includes additional forages, for example, a forage selected from alfalfa, clover, vetches, trefoils (e.g., Birdsfoot trefoil), and lespedeza. An exemplary lespedeza suitable for inclusion in the composition is sericea lespedeza (Lespedeza cuneata).

Exemplary additives or ingredients that can be incorporated in the compositions include meal, minerals, vitamins, binders (e.g., molasses), antibiotics, probiotics, prebiotics, yeasts, chelated nutrients, growth hormones, and therapeutic and/or prophylactic agents. In some preferred embodiments, the composition further includes anthelmintic agents and/or antifungal agents (e.g., short chained fatty acids). Suitable anthelmintic agents include, without limitation, benzimidazoles such as fenbendazole, thiabendazole and albendazole, ivermectins, avermectins, moxidectin and other monocyclic lactones, levamisole, and other fungal products for parasite control.

In some embodiments, the composition contains one or more plant secondary metabolites (PSMs). The PSMs can be a compound belonging to a class selected from terpenes and steroids, phenolic compounds, alkaloids, and sulfur containing compounds. Suitable PSMs include, without limitation quinine, cinnamon, nicotine, coumadin, metformin, polyphenols, paclitaxel, artemisinin, morphine, codeine, atropine, digoxin, alkaloids, and flavonoids.

In some preferred embodiments, the composition does not include a pellet binder. In some preferred embodiments, the composition does not include molasses. In some preferred embodiments, the moisture content of the composition is about 10-12%, inclusive.

The pellet compositions can be of various sizes and shapes. For example, the pellet can be cylindrical or oval. In some embodiments, the pellet has a diameter of about 6.3-10.0 mm, inclusive, and/or a length of about 13-25 mm, inclusive. In some embodiments, the density of the pellets is about 960-1120 kg/m³.

In some embodiments, the composition is formed by pelletizing a mixture containing the one or more legume forages (e.g., Arachis glabrata and/or Crotalaria juncea L.), one or more feed additives, and other forages in a pellet mill. This can involve bulk reduction by milling, compacting and/or forcing the mixture through die openings by a mechanical process to form pellets.

The disclosed compositions provide pellets as animal feed, allow for increased shelf life and stability, decreased volume, improved product handling, improved feed consumption and can be used to increase protein concentration in mixed pellets. Thus, Crotalaria juncea L. can be combined with other nutrients as a pellet to create a more complete and balanced diet.

Also disclosed are methods of using the disclosed compositions. For example, described herein is a method for improving weight gain or growth of an animal by feeding the animal the disclosed pelleted compositions. Also provided is a method for preventing or treating gastrointestinal nematode infections in an animal by feeding the animal the disclosed pelleted compositions. Animals that may benefit from the disclosed compositions include, but are not limited to equidae, ruminants, and zoo animals, for example horse, cattle (both beef and dairy), sheep, goat, pig, rabbit, camelid (e.g., camel, llama, alpaca), bison, cat, deer, elk, dog, donkey, gayal, rodent (e.g., rat, mouse, hamster), horse, mule, reindeer, water buffalo, yak, chicken, turkey, duck, goose, pheasant, quail, guineafowl, salmon, catfish, and ostrich.

Additional advantages of the disclosed methods will be set forth in part in the description which follows, and in part will be understood from the description, or can be learned by practice of the disclosed methods and compositions. The advantages of the disclosed method and compositions will be realized and attained by means of the elements and combinations particularly pointed out in the appended claims. It is to be understood that both the foregoing general description and the following detailed description are exemplary and explanatory only and are not restrictive of the invention as claimed.

### BRIEF DESCRIPTION OF THE DRAWINGS

FIG. 1 is a diagram of a pelleting system illustrating an exemplary arrangement of different machines designed to accomplish the pelleting task.

FIG. 2 is a diagram illustrating an exemplary die and roller assembly used for producing pellets. 1—Meal or mash; 2—pellets; 3—blades; 4—rollers; 5—die.

### DETAILED DESCRIPTION OF THE INVENTION

The disclosed methods and compositions can be understood more readily by reference to the following detailed description of particular embodiments and the Examples included therein and to the Figures and their previous and following description.

Small ruminants and cervids are consumed and enjoyed by many. However, such animals die frequently. They die from intestinal parasitism caused by blood sucking anemia causing nematodes, intestinal damage and malabsorption caused by intestinal protozoans, and from intensive cereal grain feeding and dysbiosis that either ends up as acidosis or acidosis produced ulcers and then overgrowth of Clostridial species of bacteria that produce very powerful toxins. It is the toxemia that drives the mortality in the end. In the case of the parasitism, anemia, hypoproteinemia, vascular leakage, and severe intestinal damage prevent assimilation of nutrients. In addition, greenhouse gas mitigation has become an embedded concern in the minds of the consumer.

Concentrated animal feeding operations (CAFO) use large amounts of human consumable cereal grains in feedyards. The feed efficiency of these practices is poor. Ruminants can prosper and should be grown on forages that cannot be utilized in the diet of man. Agricultural fossil fuel and energy usage inefficiency is also a current concern. Forage production does not have to take place on prime farmland. Perennial forages decrease fuel and energy usage and help maintain topsoils due to significantly less tillage. Perennial legumes require much less synthetic chemical use than row cropping cereal grains. Putting up forages into dry hays and silages is a strategy to feed/carry over ruminants in the non-growing months. These methods, while helpful, have shelf-life limits on the dry hay side and volume/cost of holding limits on the both sides.

All animals need adequate trace mineral nutrition for survival, welfare, and productivity needs. Permanently coupling the provision of these trace minerals with cereal grain feeding creates dependency on the system. Cereal grains must be imported from offshore during certain months. When forages are growing well cereal grains are unnecessary. Trace minerals can be independently supplied constantly (e.g., every day) to ruminants and if extra nutritional supplementation is required in late pregnancy or first/heavy milk, it should come as an incomplete feed (absent the trace minerals). Trace mineral provision can provide an easy mechanism to blend in anthelmintic or other specialty parasite control compounds into the blend rather than being forced into using cereal grain commercial feed.

Thus, there is a need for compositions and methods that circumvent these and other challenges in the field. There is a need for alternative forms of animal feeds, such as forage legumes, that provide a stable source of nutrients year-round.

### I. Definitions

The term “animal feed” as used herein means a feed ration and/or supplement produced for consumption by an animal.

The term “animal” includes, for example, bovine, porcine, equine, caprine, ovine, avian animals, seafood (aquaculture) animals, etc. Bovine animals include, but are not limited to, buffalo, bison, and all cattle, including calves, steers, heifers, cows, and bulls. Porcine animals include, but are not limited to, feeder pigs and breeding pigs, including piglets, sows, gilts, barrows, and boars. Equine animals include, but are not limited to, horses, including foals, mares, geldings and stallions. Caprine animals include, but are not limited to, goats, including does, bucks, wethers, and kids. Ovine animals include, but are not limited to, sheep, including ewes, rams, wethers, and lambs. Avian animals include, but are not limited to, birds, including chickens, quails, guinea fowls, turkeys, ducks, and ostriches (and also include domesticated birds also referred to as poultry). Seafood animals (including from salt water and freshwater sources) include, but are not limited to, fish and shellfish (such as clams, scallops, shrimp, crabs and lobster). The term “animal” also includes domesticated animals (e.g. dogs, cats, rabbits, etc.), and wildlife (e.g. deer). The term “animal” as used in this disclosure also include ruminant and monogastric animals.

As used herein, the term “ruminant” means any mammal that has a multi-compartment stomach and is associated with digestion by regurgitation and repeated chewing of a bolus or cud. Such ruminant mammals include, but are not limited to, cattle, goats, sheep, giraffes, bison, yaks, water buffalo, deer, camels, alpacas, llamas, wildebeest, antelopes and pronghorns.

“Treatment”, “treating”, or “alleviating” as used in connection with a disease or infection refers to an intervention performed with the intention of altering or inhibiting the pathology of a disorder. Treatment includes medical management of a subject (e.g., animal) with the intent to cure, ameliorate, stabilize, or prevent a disease, pathological condition, or disorder. It is understood that treatment, while intended to cure, ameliorate, stabilize, or prevent a disease, pathological condition, or disorder, need not actually result in the cure, amelioration, stabilization or prevention.

“Prevention” or “preventing” means to administer a composition to a subject (e.g., animal) at risk for an undesired condition (e.g., nematode infection). The condition can include one or more symptoms of a disease, pathological state, or disorder. The condition can also be a predisposition to the disease, pathological state, or disorder. The effect of the administration of the composition to the subject can be the cessation of a particular symptom of a condition, a reduction or prevention of the symptoms of a condition, a reduction in the severity of the condition, the complete ablation of the condition, a stabilization or delay of the development or progression of a particular event or characteristic, or reduction of the chances that a particular event or characteristic will occur.

Recitation of ranges of values herein are merely intended to serve as a shorthand method of referring individually to each separate value falling within the range, unless otherwise indicated herein, and each separate value is incorporated into the specification as if it were individually recited herein.

Use of the term “about” is intended to describe values either above or below the stated value in a range of approx. +/−10%; in other forms the values may range in value either above or below the stated value in a range of approx. +/−5%; in other forms the values may range in value either above or below the stated value in a range of approx. +/−2%; in other forms the values may range in value either above or below the stated value in a range of approx. +/−1%. The preceding ranges are intended to be made clear by context, and no further limitation is implied.

### II. Compositions

Compositions containing one or more legume forages are provided. Preferably, the legume forages include Arachis glabrata, Crotalaria juncea L., or a combination thereof. The disclosed compositions are particularly suitable as animal feed.

In some embodiments, the compositions further include additional forages, such as alfalfa, clover, vetches, trefoils (e.g., Birdsfoot trefoil), and/or lespedeza. A preferred lespedeza is sericea lespedeza (Lespedeza cuneata). In some embodiments, the compositions include Arachis glabrata and Crotalaria juncea L. In some embodiments, the compositions include Arachis glabrata and one or more lespedezas (e.g., Lespedeza cuneata). In some embodiments, the compositions include Crotalaria juncea L. and one or more lespedezas (e.g., Lespedeza cuneata). In some embodiments, the compositions include Arachis glabrata, Crotalaria juncea L., and one or more lespedezas (e.g., Lespedeza cuneata). In some embodiments, one or more forages or other plants included in the compositions are low tanning variety.

The compositions can optionally include one or more feed additives or ingredients, such as meal, minerals, vitamins, binders (e.g., molasses), anthelmintics, anticoccidials, antibiotics, probiotics, prebiotics, yeasts, chelated nutrients, growth hormones, and subtherapeutic, therapeutic, and/or prophylactic agents.

In some embodiments, the composition contains one or more plant secondary metabolites. PSMs are frequently the raw sources for ancient and modern medicines development. PSMs are classified into four main groups-terpenes and steroids, phenolic compounds, alkaloids, and sulfur containing compounds. Thus, in some embodiments, the compositions include one or more compounds belonging to terpenes and steroids, phenolic compounds, alkaloids, and/or sulfur containing compounds. Suitable PSMs include, without limitation quinine, cinnamon, nicotine, coumadin, metformin, polyphenols, paclitaxel, artemisinin, morphine, codeine, atropine, digoxin, alkaloids, and flavonoids.

In some preferred embodiments, the compositions contain one or more active PSMs, such as condensed tannins. Thus, in some embodiments, the compositions are bioactive (e.g., controlling parasitic worms). In some embodiments, the compositions are nutraceuticals. Nutraceuticals encompass compositions that combine high nutritional values and beneficial effects on health and welfare, including anthelmintic effects.

In some preferred embodiments, the compositions do not include a pellet binder. In some preferred embodiments, the compositions do not include molasses.

Preferably, the composition is in the form of a pellet. Pelleted feeds have been defined as “agglomerated feeds formed by extruding individual ingredients or mixtures by compacting and forcing through die openings by any mechanical process”. In some embodiments, the percent moisture is monitored and standardized at optimum levels. This can help prevent molding and decay of the pellet compositions. In some embodiments, finished pellet moisture content is in the range of about 5-20%, about 5-15%, about 10-20%, about 10-15%, or about 10-12%. In preferred embodiments, finished pellet moisture content is in the range of about 10-12% (e.g., 10%, 11%, or 12%).

The pellet compositions can be of various sizes and shapes. For example, the pellet can be cylindrical or oval. In some embodiments, the pellet has a diameter of about 6.3-10.0 mm, inclusive, and/or a length of about 13-25 mm, inclusive. In some embodiments, the density of the pellets is about 960-1120 kg/m³.

Examples of suitable pellet sizes include pellets less than about 1.5 inches. Other examples of suitable pellet sizes include pellets of 1 U.S. mesh to 50 U.S. mesh. Still other examples of suitable pellet sizes include pellets of 3 U.S. mesh to 40 U.S. mesh, 4 U.S. mesh to 35 U.S. mesh, or 4 U.S. mesh to 18 U.S. mesh. The term “mesh size” is the number of openings in one inch of screen. For example, a 4 U.S. mesh screen has four square openings across one linear inch of screen.

A US conversion mesh size is provided below in Table 1.

| U.S. MESH | INCHES | MICRONS | MILLIMETERS |
|---|---|---|---|
| 3 | 0.2650 | 6730 | 6.730 |
| 4 | 0.1870 | 4760 | 4.760 |
| 5 | 0.1570 | 4000 | 4.000 |
| 6 | 0.1320 | 3360 | 3.360 |
| 7 | 0.1110 | 2830 | 2.830 |
| 8 | 0.0937 | 2380 | 2.380 |
| 10 | 0.0787 | 2000 | 2.000 |
| 12 | 0.0661 | 1680 | 1.680 |
| 14 | 0.0555 | 1410 | 1.410 |
| 16 | 0.0469 | 1190 | 1.190 |
| 18 | 0.0394 | 1000 | 1.000 |
| 20 | 0.0331 | 841 | 0.841 |
| 25 | 0.0280 | 707 | 0.707 |
| 30 | 0.0232 | 595 | 0.595 |
| 35 | 0.0197 | 500 | 0.500 |
| 40 | 0.0165 | 400 | 0.400 |

### Arachis glabrata Benth

The compositions (e.g., pellets) can include Arachis glabrata benth as the only forage, or in combination with other forages such as Crotalaria juncea L., alfalfas, clovers, and/or lespedezas. In some embodiments, Arachis glabrata benth as the only forage is provided in the form of pellets. In other embodiments, Arachis glabrata benth can be pelleted in combination with other forages such as alfalfa, sunn hemp, clovers, and lespedezas.

Arachis glabrata (also known as creeping forage peanut, rhizoma peanut, rhizoma perennial peanut, perennial forage peanut, golden glory, ornamental peanut grass) is a high-quality forage plant native to Argentina, Brazil, and Paraguay vegetation. Arachis glabrata Benth. is a summer growing perennial tropical legume and a relative of the annual peanut (Arachis hypogaea). It provides high yields of forage that is mainly used for pasture, hay silage production, and ornamental ground cover. It is grown in agroforestry, under coconuts or banana trees and can be grown in stand with grasses or other legumes. It is adapted to a range of latitudes. It withstands droughts and thrives on infertile acidic soils. It is a good cover crop and a companion legume for cool or warm season grains.

Perennial peanut fills a unique niche in the lower southeastern United States because there is no other perennial warm-season legume that rivals its forage quality, persistence, and broad spectrum of uses. It is commercially produced primarily in north Florida and south Georgia. Most of this production is for hay—in particular, for horses.

Perennial peanut forage has been found to be highly nutritious for beef and dairy cattle, and goats. Goats fed perennial peanut hay had slightly greater digestibility of dry matter, fiber, and protein than those fed the alfalfa hay control. The goats also voluntarily ate more perennial peanut hay than alfalfa hay. It has been described that perennial peanut forage is a suitable protein and energy supplement feed for wintering cattle, especially for those on low protein grass hay. Thus, for ruminant animals (cattle, sheep, and goats), perennial peanut is very nutritious and well liked. The nutritional quality of perennial peanut appears to be as good as alfalfa.

### Crotalaria juncea L

The compositions (e.g., pellets) can include Crotalaria juncea L. as the only forage, or in combination with other forages such as Arachis glabrata benth, alfalfa, clovers, and/or lespedezas. In some embodiments, Crotalaria juncea L. as the only forage is provided in the form of pellets. In other embodiments, Crotalaria juncea L. can be pelleted in combination with other forages such as Arachis glabrata benth, alfalfa, clovers, and lespedezas.

Crotalaria juncea, known as brown hemp, Indian hemp, Madras hemp. or Sunn hemp, is a tropical Asian plant of the legume family (Fabaceae). C. juncea is a shrubby, herbaceous, sub-tropical annual legume that grows 3-9 ft tall. It has a long tap root with vigorous lateral roots and a thick, ribbed, pubescent (covered in short, soft hairs) stem that grows from ½ in up to 2 in diameter.

Crotalaria juncea is grown mainly in India, Brazil, and West Pakistan for its fiber. It is used in the production of twine, rug yarn, tissue paper, fish nets, sacking, canvas, and cordage. It can produce 500-810 lb/acre of fiber. It is also used as forage (e.g., for goats and cattle). C. juncea contains toxic alkaloids, particularly in the seeds and pods. However, the variety ‘Tropic Sun’ is nontoxic. Seeds contain 34.6% crude protein.

C. juncea is used as a nitrogen-fixing green manure to improve soil quality, reduce soil erosion, conserve soil moisture, suppress weeds and nematodes, and recycle plant nutrients. It grows quickly and can produce more than 5,000 lb dry matter/acre and 120 lb nitrogen/acre in 9-12 weeks

### Other Forages

Additional forages, including but not limited to, alfalfa, clover, vetches, trefoils (e.g., Birdsfoot trefoil), and/or lespedeza can be included in the compositions.

Alfalfa is a perennial flowering plant in the legume family Fabaceae. It is cultivated as an important forage crop in many countries around the world. It is used for grazing, hay, and silage, as well as a green manure and cover crop. The name alfalfa is used in North America. The name lucerne is the more commonly used name in the United Kingdom, South Africa, Australia, and New Zealand. The plant superficially resembles clover (a cousin in the same family), especially while young, when trifoliate leaves containing round leaflets predominate.

Clover or trefoil are common names for plants of the genus Trifolium including about 300 species of flowering plants in the legume or pea family Fabaceae originating in Europe. Clovers are a popular legume for high quality protein and digestibility. Several species of clover are extensively cultivated as fodder plants. The most widely cultivated clovers are white clover, Trifolium repens, and red clover, Trifolium pratense. Clover, either sown alone or in mixture with ryegrass, has for a long time formed a staple crop for silaging, for several reasons: it grows freely, shooting up again after repeated mowing; it produces an abundant crop; it is palatable to and nutritious for livestock; it fixes nitrogen, reducing the need for synthetic fertilizers; it grows in a great range of soils and climates; and it is appropriate for either pasturage.

Lespedeza is a genus of some 40 species of flowering plants in the pea family (Fabaceae), commonly known as bush clovers or Japanese clovers. Some species are grown as garden or ornamental plants, and are used as a forage crops, notably in the southern United States, and as a means of soil enrichment and for prevention of erosion. In some areas, certain species are invasive. Lespedeza, like other legumes, have root nodules that harbor bacteria capable of nitrogen fixation from the air into a soil-bound form that can be taken up by other plants. Growers can take advantage of this process by putting the plants in their fields to release nitrogen, so they can use less fertilizer.

Exemplary species of lespedeza suitable for use in the compositions include Lespedeza angustifolia, Lespedeza bicolor, Lespedeza buergeri, Lespedeza capitata, Lespedeza caraganae, Lespedeza chinensis, Lespedeza cuneata (e.g., SL Lespedeza cuneata(Dumont) G. Don A U Donnelly, S L Lespedeza cuneata(Dumont) G. Don A U Grazer, S L Lespedeza cuneata (Dumont) G. Don A U Lotan), and Lespedeza kobe.

A preferred lespedeza is sericea lespedeza (Lespedeza cuneata) preferably included in the composition at a concentration of about 5-80% sericea lespedeza hay on a dry weight basis. The animal's diet can contain sericea lespedeza hay in an amount from about 0.2 kg per kg of diet to about 1.0 kg per kg of diet, on a dry weight basis. Preferably, the diet should contain about 0.25 kg per kg of diet to about 0.8 kg per kg of diet, on a dry weight basis, and most preferably from about 0.5 kg per kg of diet to about 0.75 kg per kg of diet, on a dry weight basis, effective to reduce or eliminate gastrointestinal nematode infections. Sericea lespedeza is a long-lived, deep-rooted, drought resistant perennial that will grow on heavy, well-drained soils. It grows erect, with stems 2-4 ft tall and can be used for grazing, hay, or soil conservation. Sericea is frequently used for cover on road banks to prevent erosion. Sericea can be grown on soils too acidic and infertile to support other forage legumes. Sericea can provide moderate quality forage. However, as the stems get taller and the plant matures, the stems become highly lignified and very woody. As a result, late maturity will result in very poor forage quality and most animals will increasingly avoid areas of mature sericea. Sericea lespedeza also contains high concentrations of condensed tannins. High levels of these tannins can reduce forage digestibility. However, research has shown that these tannins can act as an anthelmintic (dewormer) to help control parasitic worms in small ruminants (e.g., goats, sheep). The use of sericea for this purpose is promising (see, e.g., U.S. Pat. No. 7,615,240) as producers seek ways to reduce the buildup of anthelmintic-resistant populations of internal parasites. Low-tannin varieties of sericea lespedeza are also available, and these are more palatable than high-tannin varieties.

### Other Ingredients

In some embodiments, the compositions (e.g., pellets) can optionally include other components, such as one or more feed additives or ingredients, such as meal, minerals, vitamins, binders, antibiotics, probiotics, prebiotics, yeasts, chelated nutrients, growth hormones, and subtherapeutic, therapeutic and/or prophylactic agents.

In some embodiments, the compositions can include any protein containing meal normally employed to meet the dietary requirements of an animal. Many of such protein containing meals are typically primarily composed of grasses, grains such as barley, oats, wheat or corn, soybean meal or a corn/soy meal mix.

Feed additives can be used, for example, to help provide a balanced diet (e.g., vitamins and/or trace minerals), to protect the animals from disease and/or stress (e.g., antibiotics, probiotics) and/or to stimulate or control growth and behavior (e.g., hormones). Additive product ingredients may include, for example: prebiotics, yeasts, chelated nutrients, growth promoters, medicinal substances, buffers, antioxidants, enzymes, preservatives, pellet-binding agents, direct-fed microbials, etc. Additive product ingredients may also include, for example, ionophores (e.g. monesin, lasalocid, laidlomycin, etc.), β-agonist (zilpaterol, ractompamine, etc.), antibiotics (e.g., chlortetracycline (CTC), oxytetracycline, bacitrain, tylosin, aureomycin), probiotics and yeast cultures, coccidiostats (e.g., amprollium, decoquinate, lasalocid, monensin), and hormones (e.g., growth hormones or hormones that inhibit estrus and/or ovulation such as melengestrol acetate), pheromones, nutraceuticals, pharmaceuticals, flavanoids and flavonoids, nutritive and non-nutritive supplements, detoxicants, etc. Some commercially available additives are sold under the trade names RUMENSIN®, BOVATEC®, DECCOX®, TYLAN®, OPTAFLEXX®, and MGA®.

Major classes of nutrients that can be included in the compositions include carbohydrates, fats, minerals, protein, vitamin, and water. These nutrient classes can be categorized as either macronutrients (needed in relatively large amounts) or micronutrients (needed in smaller quantities). The macronutrients are carbohydrates, fats, fiber, proteins, and water. The micronutrients are minerals and vitamins. The macronutrients (excluding water) provide structural material (amino acids from which proteins are built, and lipids from which cell membranes and some signaling molecules are built) and energy. Vitamins, minerals, fiber, and water do not provide energy, but are required for other reasons. Micronutrients include antioxidants and phytochemicals. Nutrients are delivered by sources of ingredients.

Suitable minerals that can be included are, for example, calcium, chlorine (as chloride ions), magnesium, phosphorus, potassium, sodium, sulfur, cobalt, copper, chromium, iodine, iron, manganese, molybdenum, nickel, selenium, vandadium, and zinc.

Suitable vitamins include, for example, vitamin A, vitamin B1, vitamin B2, vitamin B3, vitamin B4, vitamin B5, vitamin B6, vitamin B7, vitamin B9, vitamin B12, vitamin C, vitamin D, vitamin E, and vitamin K.

In some embodiments, the composition includes a binder. The binder can be water soluble, e.g., lignosulfonate, starch, or molasses (e.g., cane molasses, dried cane molasses, beet molasses, dried beet molasses, citrus molasses). Molasses is an organic by-product of cane or beet sugar refining. It is a residual heavy syrup left after the crystallization process. According to an alternative embodiment, the water-soluble binder is a blend, such as a blend of molasses, whey, and lignin.

In some embodiments, the binder may be palatable to the animal (e.g. molasses). In some embodiments, the binder may be 50% urea, molasses, bentonite, lignin sulfonate, sodium silicate and various gums, attapulgite clay, calcium aluminates, and dried or wet molasses.

The compositions (e.g., pellet) may include a combination or compound of various ingredients to deliver nutrients. Examples of ingredients include protein ingredients, grain products, grain by-products, roughage products, fats, minerals, vitamins, additives or other ingredients. Protein ingredients may include, for example, animal derived proteins such as: dried blood meal, meat meal, meat and bone meal, poultry by-product meal, hydrolyzed feather meal, etc. Protein ingredients may also include, for example, marine products such as: fish meal, crab meal, shrimp meal, condensed fish solubles, fish protein concentrate, etc. Protein ingredients may further include, for example, plant products such as: algae meal, beans, coconut meal, cottonseed meal, rapeseed meal, canola meal, linseed meal, peanut meal, soybean meal, sunflower meal, peas, soy protein concentrate, dried yeast, active dried yeast, etc. Protein ingredients may also include, for example, milk products such as: dried skim milk, condensed skim milk, dried whey, condensed whey, dried hydrolyzed whey, casein, dried whole milk, dried milk protein, dried hydrolyzed casein, etc. Grain product ingredients may include, for example, corn, milo, oats, rice, rye, wheat, etc. Grain by-product ingredients may also include, for example, corn bran, peanut skins, rice bran, brewers dried grains, distillers dried grains, distillers dried grains with solubles, corn gluten feed, corn gluten meal, corn germ meal, flour, oat groats, hominy feed, corn flour, soy flour, malt sprouts, rye middlings, wheat middlings, wheat mill run, wheat shorts, wheat red dog, feeding oatmeal, etc. Roughage product ingredients may include, for example, corn cob fractions, barley hulls, barley mill product, malt hulls, cottonseed hulls, almond hulls, sunflower hulls, oat hulls, peanut hulls, rice mill byproduct, bagasse, soybean hulls, soybean mill feed, dried citrus pulp, dried citrus meal, dried apple pomace, dried tomato pomace, straw, hay, etc. Fat product ingredients may include, for example, beef fat, poultry fat, pork fat, restaurant grease, soy oil, corn oil, tallow, hydrolyzed animal fat, hydrolyzed vegetable fat, calcium salts of long chain fatty acids, hydrogenated glycerides, etc.

### Subtherapeutic, Therapeutic and/or Prophylactic Agents

In some embodiments, the compositions further include one or more therapeutic and/or prophylactic agents. For example, the compositions can include an antibiotic, an antifungal (e.g., short chain fatty acids), an anthelmintic, or an anticoccidial agent. Anthelmintics can help control nematodes in ruminants and other animals.

Suitable anthelmintic agents include, without limitation, benzimidazoles (e.g., fenbendazole, thiabendazole and albendazole), ivermectins, avermectins, moxidectin and other macrocyclic/monocyclic lactones, levamisole and other nicotine acetylcholine receptor agonists, and anthelmintic fungal produced agents.

The disclosed compositions, with or without anthelmintic agents, can be effective in in controlling gastrointestinal nematode infections of the following genera: Toxocara, Toxascaris, Physaloptera, Ancylostoma, Uncinaria, Dipylidiurn, Hydatigena, and Trichuris in feline; Toxocara, Toxascaris, Physaloptera, Spirocerca, Ancylostoma, Uncinaria, Dipylidiurn, Taenia, Strongyloides, and Trichuris in canine; Anoplocephala, Draschia, Habronema, Trichostrongylus, Parascaris, Strongyloides, Strongylus, Oxyuris, and Probstmayria in equine; Haemonchus, Ostertagia, Telodorsagia, Trichostrongylus, Cooperia, Moniezia, Bunostomum, Nematodirus, Toxocara, Strongyloides, Oesophagostomum, Trichuris, Marshallagia, Chabertia, Skrjabinema, and Spirculoptertagia in ruminants; Ascarops, Hyostrongylus, Physocephalus, Trichostrongylus, Macracanthorhynchus, Diphyllobothrium, Ascaris, Strongyloides, Trichuris, and Oesophagostomum in swine; Capillaria, Gongylonema, Tetramaeres, Davainea, Hymenolepis, Raillietina, Ascardia, Capillaria, Strongyloides, Trichostrongylus, and Heterakis in poultry; Obeliscoides, Nematodirus, Trichostrongylus, Passalurus, and Trichuris in laboratory rabbits; Syphacia, Aspicularis, Nippostrongylus, Hymenolepis, Taenia, Moniliformis, and Heligmosomoides in laboratory rodents; and all of the aforementioned nematodes included under all of the aforementioned animal groups in exotic hoofstock and zoo animals.

### III. Methods of Making

In some embodiments, the disclosed compositions are formed by pelletizing a mixture containing the desired ingredients, for example, one or more legume forages, one or more feed additives, and other forages in a pellet mill. In some embodiments, the pelletizing process can involve compacting and/or forcing the mixture through die openings by a mechanical process to form pellets.

There are many benefits to pelletizing biomasses, such as increased density, more economical transport solutions and increased doseability. For example, pelletization of biomasses can create products that can be transported in an energy efficient way due to high density and low moisture content, generate less dust problems, and generate products homogeneous in size and, thus, more doseable, as well as more resistant towards molds and other microbes. Further, pelletization can help reduce fossil fuel use, increase renewables, decrease topsoil loss, improve utilization of all types of biomasses including waste to prevent landfill accumulation. In addition, fine biomass storage can be associated with explosions, and stored hay with high moisture content is associated with barn fires.

The general process of making a pelletized feed is well-known in the art. See, e.g., U.S. Pat. No. 3,420,671, which discloses feed and forage pellets and process for producing the same, and U.S. Pat. No. 10,743,565, both of which are hereby incorporated by reference in their entirety.

In an exemplary embodiment, the process involves mixing the feed ingredients (e.g., Arachis glabrata, Crotalaria juncea L., alfalfa hay, clover, and/or lespedeza, for example chopped to suitable sizes) with or without a suitable binder, using several percent for example of the latter, and molding or extruding the mixture to produce a pellet or briquette the size of which depends on the ultimate use. The process of producing feed pellets can roughly be described as a plastic molding operation of the extrusion type. Feed ingredients are made up of various compounds such as proteins, acids, sugars, fibers, and minerals. These products can be softened (conditioned) by the addition of heat and water. When sufficiently controlled compression is applied to the “conditioned” feed ingredients, they will form a dense mass, shaped to conform to the die against which they are pressed. When the heat and moisture is again withdrawn (dried and cooled) as to withstand moderately rough handling without excessive breakage and has retained or enhanced its nutritive value. Arachis glabrata and Crotalaria juncea L., either alone or in combination with each other or other forages such as alfalfa, sunn hemp, clovers and lespedezas, can be pelleted using methods and instrumentation known in the art, such as disclosed by the California Pelleting Process, available on the web at cpm.net/downloads/Animal %20Feed %20Pelleting.pdf, incorporated herein by reference, and reproduced in brief, below.

### The Pelleting System

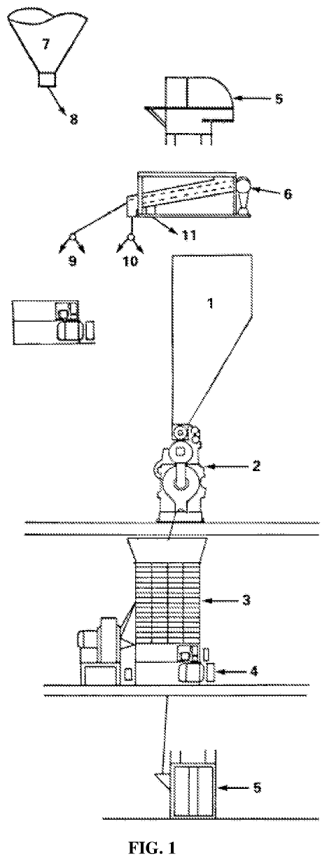

The pelleting system is composed of several different machines designed to accomplish the pelleting task. A typical system arrangement with equipment names is shown in FIG. 1.

After the feed has been mixed and before going to the pellet mill it can be processed through a scalper. This removes everything such as metal (ferrous and non-ferrous), stones, string, paper, wood, feed lumps and gives a dressed feed into the bin above the pellet mill. A pellet mill is not designed to pellet these materials, let alone the animal stomach to digest them.

In some embodiments, the pelleting process starts with a bin (FIG. 1, Item 1) in which the mixture of densified feedstock (hereafter called “mash”) is stored. From there, the mash will flow by gravity into the pellet mill (FIG. 1, Item 2). This machine is usually located on the ground or main work floor level. The hot, extruded mash (pellets) flows by gravity into a cooler (FIG. 1, Item 3) where it is held for three to six minutes while being cooled and dried by a flow of air. The air is drawn through the mass of pellets and passed into a dust collecting device, such as a cyclone collector (FIG. 1, Item 7). The dust from the outlet of the collector (FIG. 1, Item 8) is returned to the pellet mill to again be compacted into a pellet.

In preferred embodiments, the disclosed compositions are formed by a pelleting process that does not use steam.

From the cooler (FIG. 1, Item 3), the product flows through or around a pair of crumble rolls (FIG. 1, Item 4). If producing a relatively fine product is desired, about the size of cracked corn, then the pellets are passed between the crumble rolls to be crushed (cracked) to a smaller size. To retain the full pellet size, the pellets flow around the crumble rolls. From the crumble rolls, the product flows into a bucket elevator (FIG. 1, Item 5) to be raised to a higher point in the structure where the shaker (FIG. 1, Item 6) is located.

The shaker separates the product into various sizes by passing the material over several screens. Each screen is of a different opening size. This separation permits the desired product to be separated from the larger or smaller particles while being delivered to the finished product bin. The “overs” can be returned to the pellet mill for repelleting or, in the case of crumbles, to the cooler, and in turn through the crumble rolls for recrumbling. The fines or smaller material can be routed directly back to the pellet premix bin and reprocessed through the pelleting system.

Particularly, regarding the pellet mill (FIG. 1, Item 2), thoroughly mixed ingredients, now called “mash” or “meal”, are allowed to flow by gravity into a flow rate regulator called a “feeder”. The feeder is generally a screw-type with some variation in flight arrangement, such as single flight, double flight, full pitch or one-half pitch to accommodate varying conditions. It is equipped with some type of speed control, such as a variable speed electric drive. The purpose of the feeder is to provide a constant, controlled and even flow of feed to the mixing and pelleting operation.

This feeder delivers a constant and prescribed amount of the meal to a conditioning chamber. Here the mash is thoroughly mixed with steam (heat and water) and other desirable liquids, such as molasses. A mixer is provided in order to properly condition the feed. Conditioning is almost universally accomplished by the addition of controlled amounts of steam. Addition of steam supplies moisture for lubrication, liberates natural oils and, in some cases, results in partial gelatinization of starches. Uniform conditions at this point can be important for optimum results.

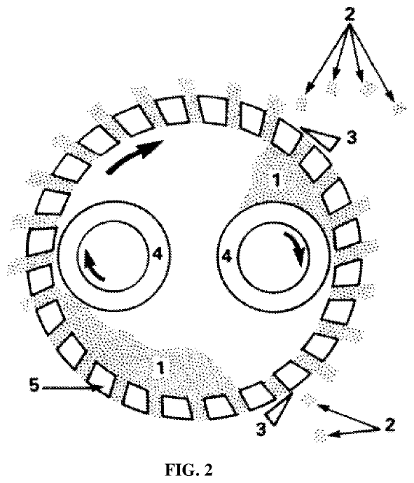

The conditioned mash then flows by gravity into the pellet mill die chamber where rollers press the softened mash (FIG. 2, Item 1) through the holes in a circular die (FIG. 2, Item 2). Stationary knives (FIG. 2, Item 3) located outside the circular, rotating die cut off the shaped, dense pellet at the proper length.

These methods of making the disclosed compositions can preserve PSMs contained therein. For example, the disclosed compositions can be made by a process that prevents PSM (e.g. condensed tannin) loss or deactivation. Thus, in some embodiments, an animal can derive benefit from the PSMs contained in the compositions, even when the compositions are stored for an extended period (e.g., 6 months, 1 year).

### IV. Methods of Use

Methods of using the disclosed compositions (e.g., pellets) are provided. In some embodiments, the compositions (e.g., pellets) are used as a compound animal feed. A compound feed refers to an animal feed blended to include two or more ingredients which assist in meeting certain daily nutritional requirements of an animal. In some embodiments, the compositions (e.g., pellets) are used as a complete animal feed. A complete feed refers to an animal feed which is a nutritionally balanced blend of ingredients designed as the sole ration to provide all the daily nutritional requirements of an animal to maintain life and promote production without any additional substances being consumed except for water. In some embodiments, the compositions (e.g., pellets) are used as a concentrate animal feed. A concentrate feed describes an animal feed that typically includes a protein source blended with supplements or additives or vitamins, trace minerals, other micro ingredients, macro minerals, etc. to provide a part of the ration for the animal. In some embodiments, the compositions (e.g., pellets) are used as a feed supplement. A supplement refers to an ingredient such as a protein source, salt, mineral, additive, or buffer that is added to an animal feed. An example of a supplement includes the calcium, zinc, manganese, copper, iodine, cobalt, selenium and other trace ingredients.

In some embodiments, the compositions can be used to improve weight gain or growth of an animal. This can involve causing the animal to ingest an effective amount of the disclosed composition (e.g., pellet). For example, the pellets can be fed to the animal in appropriate rations. In some embodiments, the improved growth is based on measurements of one or more characteristics selected from body weight, average body weight (ABW), feed intake or average feed intake (AFD), weight gain or average weight gain (AWG), and mortality adjusted feed conversion ratio (MFCR).

Also provided is a method for preventing or treating nematode infections in an animal. For example, the compositions can be used to prevent or treat gastrointestinal nematode infections by feeding the animal an effective amount of the disclosed compositions (e.g., pellet). In preferred embodiments of this method, the compositions include one or more lespedezas e.g., sericea lespedeza (Lespedeza cuneata), typically alone or optionally in combination with one or more anthelmintic agents.

In some embodiments, the compositions are administered (e.g., fed) in an effective amount. As used herein, the term “effective amount” means a quantity sufficient to provide a desired pharmacologic and/or physiologic effect, such as, to alleviate or ameliorate one or more symptoms of a disorder, disease, or condition being treated. Such amelioration only requires a reduction or alteration, not necessarily elimination. The precise quantity will vary according to a variety of factors such as subject-dependent variables (e.g., age, immune system health, weight, etc.), the disease or disorder being treated, as well as the route of administration, and the pharmacokinetics and pharmacodynamics of the agent being administered. Various forage legumes, including effective amounts thereof, that can display anthelmintic activity are discussed in Hoste H., et al., Vet Parasitol., 186(1-2):18-27 (2012), Hoste H., et al., Vet Parasitol., 212(1-2):5-17 (2015), and Hoste H., et al., Options Méditerranéennes. Series A. Num. 99. 295-310 (2011), all of which are hereby incorporated by reference in their entirety.

Thus, in some embodiments, the compositions are provided to an animal in an effective amount to prevent or treat a nematode infection in the animal. In some embodiments, the compositions are provided to an animal in an effective amount to improve weight gain and/or growth of the animal.

Animals that may be fed or administered the disclosed compositions include, but are not limited to equidae, cervidae, ruminants, and zoo animals. Suitable animals include, without limitation, horse, cattle (both beef and dairy), sheep, goat, pig, rabbit, camelid (e.g., camel, llama, alpaca), bison, cat, deer, dog, donkey, gayal, rodent (e.g., rat, mouse, hamster), horse, mule, reindeer, water buffalo, yak, chicken, turkey, duck, goose, pheasant, quails, guineafowl, salmon, catfish, and ostrich.

The use of one or more forages in the disclosed composition has several advantages. Forage production can be local and can eliminate the need for long complex supply chains. Forage production is also less water and less energy intense. Forages can be grown on marginal land not used for grain production. Stored forages are routinely used by ruminant animals to bridge gaps in seasonal transition from cold weather forages to warm weather forages regardless of whether these are annual or perennial. Forage production in the south maximizes the climate systems that produce “the sweet grasses of the subtropics” and involves long growing seasons that maximize yield per acre and hence producer returns. Forage production and usage in the south eliminates the seasonal aspects of grain production and the need to import from foreign countries in the “off season”. Forages can be perennial crops that don't require routine plowing and planting cycles. Perennial crops once established require less chemicals for production. Forages can be legumes which fix nitrogen and hence do not require constant nitrogen fertilizer inputs. Plant diversity can also be increased leaving cereal grains for human consumption. Many annual plantings are from hybrid seeds that are proprietary and expensive. Many of these are genetically modified. Some forage crops have excellent nutritional specifications but poor handling/re-handling characteristics. This challenge can be overcome with pelleting.

Food products for animals are usually obtained according to modern production process in form of pellets, which have proved to be particularly suitable for feeding various animal species and in particular for domestic species such as dogs and cats. Pelleted animal feeds are typically agglomerated feeds formed by extruding individual ingredients or mixtures by compacting and forcing through die openings by any mechanical process. Basically, the purpose of pelleting is to take a finely divided, sometimes dusty, unpalatable and difficult-to-handle feed material and, by using high heat, moisture (steam-conditioning) and pressure, form it into larger particles.

The pelleted forage compositions described herein have many advantages. For example, the disclosed compositions provide pellets as animal feed, allow for increased shelf life and stability, decreased volume, improved product handling, improved feed consumption, and can be used to increase protein concentration in mixed pellets.

Forage dry hays deteriorate with storage because of oxidation, moisture migration, and the presence of spoilage microorganisms. Pelleting reforms the biomass and transforms it into a more stable form where only a small surface area is exposed to the environment after pelleting. The nutrients in the interior are “protected” from exposure. The reformation and densification of the biomass improves fiber digestion and feed utilization. The inhibition of and “die off” of spoilage microorganisms once the forage has entered and exited the pelleting die also improves shelf life and nutrient stability. The temperature and pressure also condition the feedstuff making components more available nutritionally.

By assaying forages and adjusting component inclusion, pelleting can produce a much more consistent product than dried hays or sileage/baleage with a proper proximate analysis label on the bag or tote; something that is not possible with commerce in dried hays. Bagged feeds, including pellets, are generally required to at least have a minimal analysis on the bag tag that states protein, fat, fiber, and ash content. Diets can also be prepared according to the life stage needs of the animal.

It is contemplated that pelleting can also allow for increased feed intake along with the improved and preserved nutritional profile (greater fermentable carbohydrates) and an increase in shelf life. Pelleting can remove dusts and fines from the product which may minimize the disease recurrent airway obstruction or “heaves” in horses. Senior animals e.g., with old and/or missing teeth can thrive on pelleted forages because its use requires less chewing. Additionally, younger animals, who may hurry through their daily ration aliquot, can be slowed down by soaking of the forage pellet.

Pelleting of Sunn hemp addresses a primary physical quality problem for its use and allows all of the plant to be utilized without the “sorting” economic losses.

Pelleting results in major volume reductions and consistent weight to volume ratios. Pelleting compresses the volume density to 4.85 times that of dry hay making shipping more efficient on wrapped pallets. Pellets are considered weed free as the temperature and pressure of die passage interferes with germination. Pelleted rations can be made as complete feeds (incorporating trace minerals) and incomplete feeds for those who feed trace minerals free choice all year long while taking advantage of growing forages. Further, in pellets, the biomass is sorted and broken run over magnets to exclude metal and dead bugs, dead crushed animals, live rodents, and twigs are removed from the stream.

Furthermore, when cereal grains are fed to ruminant livestock, the animal has no chance to consume plant secondary metabolites (PSM) many of which are now known to have healing and pharmaceutically active characteristics. PSMs total some 30,000-40,000 compounds many of which have been commercialized by man for their pharmaceutically active nature. These include quinine, cinnamon, nicotine, coumadin, metformin, polyphenols, paclitaxol, artemisinin, morphine, codeine, atropine, digoxin, and many others. It is now appreciated that some of these plant secondary metabolites can fight parasites without drug use, eliminate bloating, improve nitrogen utilization and muscle accretion, mitigate greenhouse gases, and improve reproduction in ruminants. However, consumption of PSMs is improved with forage (e.g., pelleted forage) feeding due to improved shelf life and reduced loss of PSMs and other nutrients. Pelleting also standardizes moisture content and the heat and pressure of passing through the pelleting die kills off microorganisms and inactivates enzymes that are involved in spoilage or degradation of the active PSMs.

Additional advantages are contemplated. For example, while forage crops vary in protein and other component content by season and stage of maturity, pelleting of forages as disclosed herein can permit testing forage crop lots and standardization of the final product. In addition, grinding and pelleting involves physical methods that enhance the utilization of fiber. Pelleting can reduce dustiness and particle size. Thus, wastage and “picking” of hay stuffs can be eliminated. Pelleting can reduce volume and increase the density of the material, thereby making handling and shipping much easier. This increases feed intake and lowers feed conversion ratios.

The pelleted animal feed compositions can be stored, e.g., in bulk totes or bags, greatly reducing harborage and rodent infestation. Pelleting and storage in bulk totes or bags can also improve shelf life and store up nutrients for deficit periods of the season or year.

In some embodiments, the inbound and pelleted product is assayed for quality. Harvesting of leguminous plants at the flowering stage produces pellets of the highest total digestible nutrient content producing a standard high-quality product. The disclosed legume containing products will benefit greatly by pelleting because the pharmaceutically active compounds can be protected by the process.

It is also contemplated that due to their condensed nature, pellets take up less storage area than an equal weight of the same forage in the form of baled hay. Pellets are usually less dusty than hay. This can be a big benefit for equine respiratory health, especially for horses with conditions such as recurrent airway obstruction (or heaves). Pellets can also be easier to chew and easier to digest. This allows for digestion of a greater proportion of the feed, which can help animals that struggle to maintain weight. It also means less manure production, because more of the feed is utilized (an important consideration for some barns).

The disclosed compositions and methods can be further understood through the following numbered paragraphs.

1. A composition comprising Arachis glabrata Benth formed by extruding a mixture comprising Arachis glabrata Benth and optionally, one or more feed additives, by compacting and forcing through die openings by a mechanical process to form pellets.
2. The composition of paragraph 1, wherein the mixture further comprises a forage selected from the group consisting of alfalfa, sunn hemp, and clovers and lespedezas.
3. A method for improving animal weight gain or growth of animals comprising causing the animal to ingest the composition of paragraph 1 or 2.
4. The method of paragraph 3, wherein the animal is an equidae, ruminant or zoo animals.
5. The method of paragraph 3 or 4, wherein the animal is selected from the group consisting of horse, cattle (both beef and dairy), sheep, goat, pig, rabbit, salmon, catfish, guineafowl, and ostrich.
6. A composition comprising Crotalaria juncea L. formed by extruding a mixture comprising Crotalaria juncea L. and optionally, one or more feed additives, by compacting and forcing through die openings by a mechanical process to form pellets.
7. The composition of paragraph 6, wherein the mixture further comprises a forage selected from the group consisting of alfalfa, and clovers and lespedezas.
8. A method for improving animal weight gain or growth of animals comprising causing the animal to ingest the composition of paragraphs 1 or 2.
9. The method of paragraph 8, wherein the animal is an equidae, ruminant or zoo animals.
10. The method of paragraph 8 or 9, wherein the animal is selected from the group consisting of horse, cattle (both beef and dairy), sheep, goat, pig, rabbit, and ostrich.
11. An animal feed composition comprising one or more legume forages and optionally, one or more feed additives or ingredients, wherein the composition is in the form of a pellet, and wherein the one or more legume forages is selected from the group consisting of Crotalaria juncea L., Arachis glabrata benth, and combinations thereof.
12. The composition of paragraph 11, wherein the composition further comprises a forage selected from the group consisting of alfalfa, clover, vetch, trefoil, lespedeza, and a combination thereof, optionally wherein the one or more legume forages or other forage are low tanning variety.
13. The composition of paragraph 12, wherein the lespedeza is sericea lespedeza (Lespedeza cuneata).
14. The composition of any one of paragraphs 11-13, wherein the one or more additives or ingredients is selected from meal, minerals, vitamins, binders, rumen protected amino acids or fats, antibiotics, probiotics, prebiotics, yeasts, chelated nutrients, growth hormones, anticoccidials, and therapeutic and/or prophylactic agents.
15. The composition of any one of paragraphs 11-14 further comprising an anthelmintic agent and/or antifungal agent, optionally wherein the anthelmintic agent is selected from the group consisting of benzimidazoles, ivermectins, avermectins, moxidectin and other monocyclic lactones, and levamisole; and/or wherein the antifungal agent is a short chain fatty acid.
16. The composition of any one of paragraphs 11-15, wherein the composition comprises one or more plant secondary metabolites, optionally wherein the one or more plant secondary metabolites are not degraded and/or belong to a class selected from terpenes/steroids, phenolics, alkaloids, and sulfur containing compounds; optionally wherein the one or more plant secondary metabolites are selected from the group consisting of quinine, cinnamon, nicotine, coumadin, metformin, polyphenols, paclitaxel, artemisinin, morphine, codeine, atropine, digoxin, alkaloids, and flavonoids.
17. The composition of any one of paragraphs 11-16, wherein the composition does not comprise a pellet binder.
18. The composition of any one of paragraphs 11-17, wherein the composition does not comprise molasses.
19. The composition of any one of paragraphs 11-18, wherein the moisture content of the composition is about 10-12%, inclusive.
20. The composition of any one of paragraphs 11-19, wherein the pellet is cylindrical or oval.
21. The composition of any one of paragraphs 11-20, wherein the pellet has a diameter of about 6.3-10.0 mm, inclusive, and/or a length of about 13-25 mm, inclusive.
22. The composition of any one of paragraphs 12-21, wherein the composition is formed by pelletizing a mixture comprising the one or more legume forages, one or more feed additives, and forages in a pellet mill.
23. The composition of paragraph 22, wherein the pelletizing comprises bulk reduction by milling, compacting and/or forcing the mixture through die openings by a mechanical process to form pellets.
24. A method for improving weight gain or growth of an animal comprising feeding the animal the composition of any one of paragraphs 11-23.
25. A method for preventing or treating gastrointestinal nematode infections in an animal comprising feeding the animal the composition of any one of paragraphs 11-23.
26. The method of paragraph 24 or 25, wherein the animal is an equidae, ruminant, or zoo animal.
27. The method of any one of paragraphs 24-26, wherein the animal is selected from the group consisting of horse, cattle (both beef and dairy), sheep, goat, pig, rabbit, camelid (camel, llama, alpaca), bison, cat, deer, dog, donkey, gayal, rodent (rat, mouse, hamster), horse, mule, reindeer, water buffalo, yak, chicken, turkey, duck, goose, pheasant, quail, salmon, catfish, guineafowl, and ostrich.

It is understood that the disclosed methods and compositions are not limited to the particular methodology, protocols, and reagents described as these can vary. It is also to be understood that the terminology used herein is for the purpose of describing particular embodiments only, and is not intended to limit the scope of the present invention which will be limited only by the appended claims.

Those skilled in the art will recognize, or be able to ascertain using no more than routine experimentation, many equivalents to the specific embodiments of the method and compositions described herein. Such equivalents are intended to be encompassed by the following claims.

I claim:

1. An animal feed composition comprising one or more legume forages and optionally, one or more feed additives or ingredients, wherein the composition is in the form of a pellet, and wherein the one or more legume forages is selected from the group consisting of Crotalaria juncea L., Arachis glabrata benth, and combinations thereof.

2. The composition of claim 1, wherein the composition further comprises a forage selected from the group consisting of alfalfa, clover, vetch, trefoil, lespedeza, and a combination thereof.

3. The composition of claim 2, wherein the lespedeza is sericea lespedeza (Lespedeza cuneata).

4. The composition of claim 1, wherein the one or more additives or ingredients is selected from meal, minerals, vitamins, binders, rumen protected amino acids or fats, antibiotics, probiotics, prebiotics, yeasts, chelated nutrients, growth hormones, anticoccidials, and therapeutic and/or prophylactic agents.

5. The composition of claim 1 further comprising an anthelmintic agent or antifungal agent.

6. The composition of claim 5, wherein the anthelmintic agent is selected from the group consisting of benzimidazoles, ivermectins, avermectins, moxidectin and other monocyclic lactones, and levamisole; or wherein the antifungal agent is a short chain fatty acid.

7. The composition of claim 1, wherein the composition comprises one or more plant secondary metabolites, optionally wherein the one or more plant secondary metabolites are not degraded.

8. The composition of claim 7, wherein the one or more plant secondary metabolites belong to a class selected from terpenes, steroids, phenolics, alkaloids, and sulfur containing compounds.

9. The composition of claim 7, wherein the one or more plant secondary metabolites are selected from the group consisting of quinine, cinnamon, nicotine, coumadin, metformin, polyphenols, paclitaxel, artemisinin, morphine, codeine, atropine, digoxin, alkaloids, and flavonoids.

10. The composition of claim 1, wherein the composition does not comprise a pellet binder.

11. The composition of claim 1, wherein the composition does not comprise molasses.

12. The composition of claim 1, wherein the moisture content of the composition is about 10-12%, inclusive.

13. The composition of claim 1, wherein the pellet is cylindrical or oval.

14. The composition of claim 1, wherein the pellet has a diameter of about 6.3-10.0 mm, inclusive, and/or a length of about 13-25 mm, inclusive.

15. The composition of claim 2, wherein the composition is formed by pelletizing a mixture comprising the one or more legume forages, one or more feed additives, and forages in a pellet mill.

16. The composition of claim 15, wherein the pelletizing comprises bulk reduction by milling, compacting and/or forcing the mixture through die openings by a mechanical process to form pellets.

17. A method for improving weight gain or growth of an animal comprising feeding the animal the composition claim 1.

18. A method for preventing or treating gastrointestinal nematode infections in an animal comprising feeding the animal the composition of claim 1.

19. The method of claim 17, wherein the animal is an equidae, ruminant, or zoo animal.

20. The method of claim 17, wherein the animal is selected from the group consisting of horse, cattle (both beef and dairy), sheep, goat, pig, rabbit, camelid (camel, llama, alpaca), bison, cat, deer, dog, donkey, gayal, rodent (rat, mouse, hamster), horse, mule, reindeer, water buffalo, yak, chicken, turkey, duck, goose, pheasant, quail, salmon, catfish, guineafowl, and ostrich.
